(19) United States
(12) Patent Application Publication
(10) Pub. No.: US 2003/0066739 A1
(43) Pub. Date: Apr. 10, 2003

(54) Controller with tactile feedback

(76) Inventors: Roger D. Rickenbach, Logan, UT (US); Cathal Sheehan, Douglas (IE); Steven Archibald, Ogden, UT (US); Malcolm R. Harvey, Hyde Park, UT (US); Padraig Keane, BallyNoe Cobh (IE); Tracy William Lay, Ogden, UT (US); Maurice O'Brien, Riverstown (IE); Alexy Yessayan, Ogden, UT (US)

Correspondence Address: Howard J. Klein, KLEIN, O'NEILL & SINGH, 2 Park Plaza, Siute 510, Irvine, CA, 92614, US

(21) Appl. No.: 09/897,217

(22) Filed: Jul. 2, 2001

(51) Int. Cl. H01H 9/26

(52) U.S. Cl. 200/5 R

(57) ABSTRACT

A controller that provides tactile feedback to an operator comprises a base having force-sensing elements disposed thereon, the base defining a sensing plane having first and second orthogonal axes therein, and a force-transmitting member orthogonally disposed with respect to the base, the force-transmitting member defining a third axis mutually orthogonal with the first and second axes. The force transmitting member moves at least along the third axis in response to an applied force, both to generate an electrically discernible indication and to provide tactile feedback to an operator.

### CROSS-REFERENCE TO RELATED APPLICATION

Not Applicable

### FEDERALLY SPONSORED RESEARCH OR DEVELOPMENT

Not Applicable

### BACKGROUND OF THE INVENTION

This invention relates generally to a controller configured to gather data inputs about multiple axes and in particular to a controller that provides position control signals for a cursor on a display, and is more particularly toward a cursor position controller that provides tactile feedback to an operator.

Although some computer operating systems are command-line oriented, requiring an operator to enter a command and a set of parameters in order to obtain a desired result, many computer users are more comfortable with a graphical user interface (GUI) that is menu-more driven. In order to permit easy selection of menu alternatives, a computer display cursor is generally provided to more easily enable the operator to view and select a desired operation from various menus.

A mouse is a common position control device that can be moved about on a flat surface to induce corresponding movement of a cursor on a computer screen. A mouse is generally equipped with one or more switches disposed on an upper housing of the mouse. These switches are easily adaptable for selecting choices from displayed menus, or for program lauch through icons displayed on the computer screen.

Trackballs are also used as cursor control devices. A trackball is much like an inverted mouse, in which the user can rotate a ball with the fingertips to elicit the desired cursor response. A trackball is also equipped with one or more switches adapted to user-select operation. to elicit the desired cursor response. A trackball is also equipped with one or more switches adapted to user-select operations.

As useful and ubiquitous as the mouse and trackball have become, however, these input devices are not readily adaptable to laptop and palmtop computer applications, primarily because of a lack of space, both within these smaller computer housings and adjacent the machines in their normal modes of use. Small computer systems such as laptops and palmtops are often used on airplanes or trains, where work space next to the machine to accommodate a conventional mouse may be unobtainable.

Manufacturers have responded to this need for a self-contained control device in various ways. There are systems available in which a trackball device is disposed on an upper housing of a laptop machine, but operation is a bit clumsy on such a small scale, and many users disdain the trackball in favor of the more familiar mouse in any event.

Of course, there are other cursor control devices available as well. The joystick is a popular alternative, particularly for computer-gaming applications. U.S. Pat. No. 4,492,830 to Kim describes a control joystick adaptable to computer game control that includes a switch pushbutton (for “fire control” within game applications) integrated within the joystick itself. However, Kim's implementation is complex, with a number of moving parts, and would be impossible to integrate within the reduced-space environment of a laptop keyboard layout. U.S. Pat. No. 4,414,438 to Maier et al. describes a video game control joystick whose handle is designed to simulate the flight control stick of an aircraft, with a thumb-operated trigger switch located on top of the handle. This technology also incorporates a number of moving parts, and would present great difficulties in scaling for inclusion in a laptop computer.

Some examples of cursor control joysticks designed to be centrally disposed within the keyboard area of a laptop machine are known in the art. Most of these joystick implementations are rigid. In other words, there is no movement of the joystick detectable to the user as lateral forces are applied to move the cursor in the x-y plane. For example, Cali et al., in U.S. Pat. No. 5,489,900, describe a rigid force sensitive transducer specifically designed for laptop computer applications, but Cali et al. do not address the need for a selection mechanism incorporated into the transducer structure.

Seffernick et al., in U.S. Pat. No. 6,002,388, suggest that a flexible “interposer” positioned beneath the upstanding control stick will transmit a sense of motion of the joystick along a vertical axis to the user as feedback, although it is unclear how the degree or nature of travel along the vertical direction serves to transmit a tactile sensation to the operator that is indicative of a desired action being accomplished. Known joystick implementations for the most part fail to address the issue of selection of a displayed alternative is a satisfactory manner. Some method of selection, such as a switch, is necessary, and known implementations do not provide a conveniently located actuation device that accomplishes the selection function while providing the operator with desirable tactile feedback to indicate to the operator that the intended operation of the controller apparatus is being carried out. Consequently, a need arises for a controller implementation that is suitably rugged for portable applications, relatively economical to manufacture, and that provides easily detectable tactile feedback to an operator that activation in the desired direction is actually taking place.

### SUMMARY OF THE INVENTION

These needs and others are satisfied by the present invention, in which a controller that provides tactile feedback to an operator comprises a base having force-sensing elements disposed thereon, the base defining a sensing plane having first and second orthogonal axes therein, a force-transmitting member orthogonally mounted to the base, the force-transmitting member defining a third axis mutually orthogonal with the first and second axes, a first pattern of electrically conductive traces disposed upon an upper surface of the base, a second pattern of electrically conductive traces disposed upon at least one side portion and a top portion of the force-transmitting member, and an electrically conducting and resiliently deformable contact member positioned adjacent the top portion of the force-transmitting member.

In one form of the invention, the base comprises a ceramic substrate having force sensing resistors disposed upon an underside thereof, and patterns of conductive traces providing electrical connections between the force sensing resistors and electrical contacts disposed proximate corner regions of the substrate underside. The force transmitting member comprises an upstanding post of rectangular cross-section affixed to the base, and the post may be formed from ceramic material.

In accordance with one aspect of the invention, a cap is movably coupled to the force transmitting member and substantially encloses the deformable contact member, such that the cap responds to a predetermined force exerted by the operator along the third axis by moving along the third axis in response to the force until the deformable contact member makes electrical contact with the second pattern of conductive traces, and by returning to an initial position upon reduction of the force below a threshold level.

In accordance with another aspect of the invention, a controller that provides tactile feedback to an operator comprises a base having force-sensing elements disposed thereon, the base defining a sensing plane having first and second orthogonal axes therein, a force-transmitting member orthogonally mounted to the base, the force-transmitting member defining a third axis mutually orthogonal with the first and second axes, a cover formed from electrically non-conductive material, the cover having a bottom portion and an upstanding portion thereon, wherein the upstanding portion accommodates and substantially surrounds the force transmitting member and the bottom portion is in contact with the base, a first pattern of electrically conductive traces disposed upon the bottom portion of the cover, a second pattern of electrically conductive traces disposed upon at least one side portion and a top portion of the upstanding portion of the cover, and an electrically conducting and resiliently deformable contact member positioned adjacent the top portion of the upstanding portion of the cover.

The base comprises a ceramic substrate having force sensing resistors disposed upon an underside thereof, and patterns of conductive traces provide electrical connections between the force sensing resistors and electrical contacts disposed proximate corner regions of the substrate underside.

In one form of the invention, the force transmitting member comprises an upstanding post of rectangular cross-section affixed to the base. The post may be formed from ceramic material. The cover may be formed by a two-shot molding process having conductive traces formed therein through plating processes.

In another form of the invention, an electrically non-conductive cap is movably coupled to the upstanding portion of the cover and substantially encloses the deformable contact member, such that the cap responds to a predetermined force exerted by the operator along the third axis by moving along the third axis in response to the force until the deformable contact member makes electrical contact with the second pattern of conductive traces, and by returning to an initial position upon reduction of the force below a threshold level. Preferably, the electrically non-conductive cap includes a bowl-shaped upper portion accommodating a thumb of the operator.

In accordance with yet another aspect of the invention, a controller that provides tactile feedback to an operator comprises a base having force-sensing elements disposed thereon, the base defining a sensing plane having first and second orthogonal axes therein, a force-transmitting member orthogonally mounted to the base, the force-transmitting member defining a third axis mutually orthogonal with the first and second axes, and a feedback assembly affixed to the force-transmitting member, the feedback assembly including an actuator disposed along the third axis and an electrical switch coupled to the actuator, wherein the actuator responds to a predetermined actuation force exerted by the operator along the third axis by moving along the third axis in response to the actuation force, and by returning to an initial position upon reduction of the actuation force below a threshold level, the moving and returning being responsive to an electrically conducting and resiliently deformable switch element included in the electrical switch.

In one form of the invention, the base comprises a ceramic substrate having force sensing resistors disposed upon an underside thereof, and patterns of conductive traces provide electrical connections between the force sensing resistors and electrical contacts disposed proximate corner regions of the substrate underside. The force transmitting member comprises an upstanding post of rectangular cross-section affixed to the base, and the post may be formed from ceramic material.

In one form of the invention, the feedback assembly further includes a base portion formed from an electrically non-conductive material that encloses a printed circuit board with a pattern of electrical switch contacts disposed on an upper surface thereof.

The actuator of the feedback assembly further responds to force exerted by the operator, the force having at least a force component parallel to the sensing plane, by moving laterally in the direction of the exerted force component.

In accordance with yet a further aspect of the present invention, a controller that provides tactile feedback to an operator comprises a base having force-sensing elements disposed thereon, the base defining a sensing plane having first and second orthogonal axes therein, first and second patterns of conductive traces disposed on an upper surface of the base, an electrically conducting and resiliently deformable contact member positioned adjacent the upper surface of the base, a force-transmitting member orthogonally disposed with respect to the base, and positioned adjacent the deformable contact member, the force-transmitting member defining a third axis mutually orthogonal with the first and second axes, a housing through which the force-transmitting member protrudes, the housing affixed to the base and substantially enclosing the patterns of conductive traces and the deformable contact member, wherein the force-transmitting member responds to a predetermined actuation force exerted by the operator along the third axis by moving along the third axis in response to the actuation force, and by returning to an initial position upon reduction of the actuation force below a threshold level.

In one form of the invention, the base comprises a ceramic substrate having force sensing resistors disposed upon an underside thereof, and patterns of conductive traces provide electrical connections between the force sensing resistors and electrical contacts disposed proximate corner regions of the substrate underside. Preferably, a cap is affixed to an upper portion of the force-transmitting member.

In one form of the invention, the force-transmitting member further responds to force exerted by the operator, the force having at least a force component parallel to the sensing plane, by moving laterally in the direction of the exerted force component.

In accordance with still a further aspect of the present invention, a controller that provides tactile feedback to an operator comprises a base having force-sensing elements disposed thereon, the base defining a sensing plane having first and second orthogonal axes therein, at least first and second upstanding conductive posts electrically and mechanically coupled to the base, an electrically non-conductive support member affixed to the base, the support member having openings therethrough to accommodate the at least first and second conductive posts, such that at least a portion of the posts protrudes through an upper surface of the support member, an electrically conducting and resiliently deformable contact member positioned adjacent the upper surface of the support member, proximate the protruding portions of the posts, a force-transmitting member orthogonally disposed with respect to the support member, and positioned adjacent the deformable contact member, the force-transmitting member defining a third axis mutually orthogonal with the first and second axes, a housing through which the force-transmitting member protrudes, the housing affixed to the support member and substantially enclosing the support member and the deformable contact member, wherein the force-transmitting member responds to a predetermined actuation force exerted by the operator along the third axis by moving along the third axis in response to the actuation force, and by returning to an initial position upon reduction of the actuation force below a threshold level.

In one form of the invention, the base comprises a ceramic substrate having force sensing resistors disposed upon an underside thereof, and patterns of conductive traces provide electrical connections between the force sensing resistors and electrical contacts disposed proximate corner regions of the substrate underside.

Preferably, the first and second upstanding conductive posts are staked to the base through openings provided therein. The electrically nonconductive support member affixed to the base may be formed from a block of ceramic material substantially rectangular in cross-section. Preferably, the first and second upstanding conductive posts, in combination with the electrically conducting and resiliently deformable contact member, form an electrical switch having electrical terminals disposed upon the base.

In accordance with yet a further aspect of the invention, a controller that provides tactile feedback to an operator comprises a base having force-sensing elements disposed thereon, the base defining a sensing plane having first and second orthogonal axes therein, a force-transmitting member orthogonally mounted to the base, the force-transmitting member defining a third axis mutually orthogonal with the first and second axes, an electrical contact area disposed at an end of the force-transmitting member distal from the base, an electrically conducting and resiliently deformable contact member positioned adjacent the electrical contact area, a resilient, nonconductive pushbutton assembly disposed adjacent the deformable contact member, and an attachment member through which the non-conductive pushbutton assembly protrudes, the attachment member removably retaining the non-conductive pushbutton member proximate the deformable contact member, wherein the non-conductive pushbutton assembly responds to a predetermined actuation force exerted by the operator along the third axis by moving along the third axis in response to the actuation force, and by returning to an initial position upon reduction of the actuation force below a threshold level.

In one form of the invention, the base comprises a ceramic substrate having force sensing resistors disposed upon an underside thereof, and patterns of conductive traces providing electrical connections between the force sensing resistors and electrical contacts disposed proximate corner regions of the substrate underside. Preferably, the non-conductive pushbutton assembly comprises a silicone rubber assembly having a pushbutton integrally formed therein. The attachment member may comprise a metal clip having an opening through which the pushbutton assembly protrudes, the attachment member including engagement members removably engaged with mating features on the force transmitting member.

In accordance with one form of the invention, the force transmitting member comprises a plastic post of rectangular cross-section. The post may include a switch assembly of rectangular cross-section secured to one end, wherein the switch assembly includes electrical contacts depending therefrom, the electrical contacts disposed at least in part within recesses formed in the post.

The post may include a switch integrally formed therein, wherein switch contact areas and at least a portion of associated electrical contacts are insert-molded within the post. The post may be formed in a two-shot molding process in which switch contact areas and associated electrical contacts are formed therein by metallization.

In accordance with still a further aspect of the present invention, a controller that provides tactile feedback to an operator comprises a base, said base defining a sensing plane having first and second orthogonal axes therein, a force-transmitting member orthogonally mounted to said base, said force-transmitting member defining a third axis mutually orthogonal with said first and second axes, force-sensing elements for sensing force along said first and second orthogonal axes, a resiliently deformable member positioned adjacent said top portion of said force-transmitting member, wherein a portion of said deformable member flexes in response to the exertion of an actuation force in a direction along said third axis from an initial position to a deformed position and returning to the initial position upon reduction of said actuation force below a threshold level, and a transducer switch for producing an electrically discernible switching signal in response to an actuation force exerted in a direction along said third axis.

Optionally, the transducer switch may comprises force-sensing elements for sensing force along said third orthogonal axes. In this optional embodiment, the force-sensing elements for sensing force along the first and second orthogonal axes may also be used to sense force along said third orthogonal axis. Alternatively, the transducer switch may comprise a first and second pattern of contacts formed in the upper surface of said force transmitting member in combination with the resiliently deformable member, wherein contact is made between the first and second patterns of contacts when the deformable member flexes to a deformed position and provides a conduction path between the first and second pattern of contacts.

The force-sensing elements may be disposed on the base or on the force transmitting member or a combination thereof.

The resiliently deformable member may be dome shaped and the force transmitting member may be a cylindrical post having a recess formed therein which is shaped to receive the resiliently deformable member

Further objects, features, and advantages of the present invention will become apparent from the following description and drawings.

### BRIEF DESCRIPTION OF THE DRAWINGS

FIG. 1 is a perspective view of a portion of a controller in accordance with the present invention;

FIG. 2 is a bottom view of the controller of FIG. 1;

FIG. 3 depicts an enlarged view of a portion of the controller of FIG. 1;

FIG. 4 illustrates the controller of FIG. 3 subjected to an activating force;

FIG. 5 is a cutaway view of a controller in accordance with another embodiment of the present invention;

FIG. 6 is a perspective view of a controller in accordance with yet another embodiment of the present invention;

FIG. 7 is an exploded view of the controller of FIG. 6;

FIG. 8 is a section view of the controller of FIG. 6 taken along section lines 8-8.

FIG. 9 is a perspective view of a controller in accordance with still another embodiment of the present invention;

FIG. 10 is an exploded view of the controller of FIG. 9;

FIG. 11 is a section view of the controller of FIG. 9 taken along section lines 11-11;

FIG. 12 is a perspective view of a controller in accordance with yet a further embodiment of the present invention;

FIG. 13 is an exploded view of the controller of FIG. 12;

FIG. 14 is a section view of the controller of FIG. 12 taken along section lines 14-14;

FIG. 15 is a perspective view of a controller in accordance with still a further embodiment of the present invention;

FIG. 16 is an exploded view of the controller of FIG. 15;

FIG. 17 illustrates an alternative electrical contact configuration,

FIG. 18 is an exploded view of a controller in accordance with still a further embodiment of the present invention, and

FIG. 19 is a line drawing of alternative portion for the controller of FIG. 18.

### DETAILED DESCRIPTION OF THE INVENTION

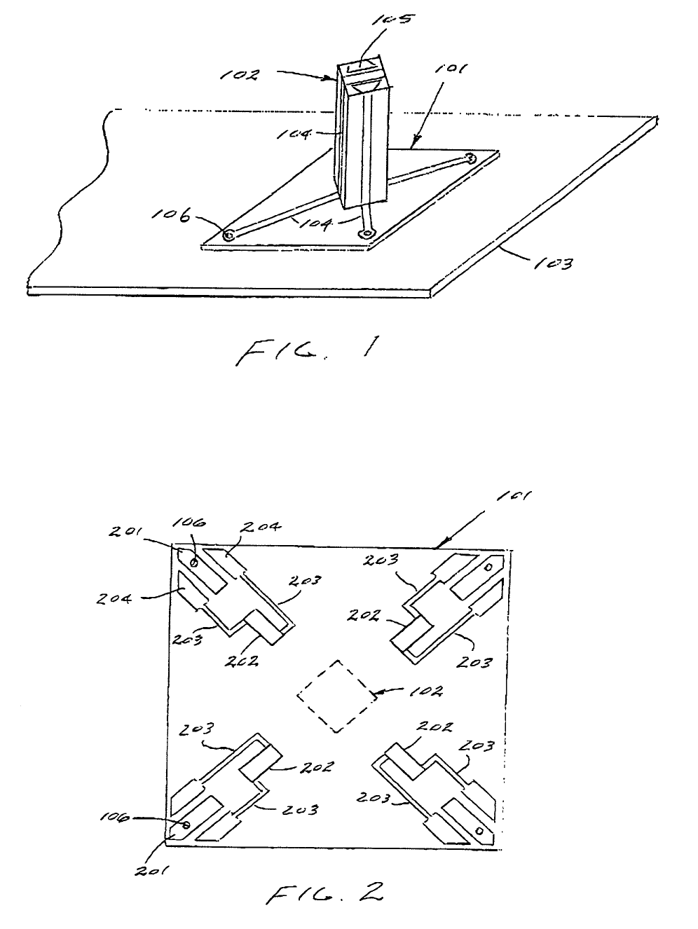

There is described herein a controller with tactile feedback that offers distinct advantages when compared to the prior art. FIG. 1 depicts an isometric (detecting control inputs about three mutually orthogonal axes) controller that includes a base 101 and a force transmitting member or post 102 that is orthogonally mounted to the base 101. The post 102 may be secured to the base 101 by permanent adhesive, for example, or other form of mechanically sound bonding. There may, for example, be a hole provided in the base 101 to press-fit with a correspondingly shaped projection from the post 102, and this mechanical interconnection could then be augmented by adhesive or other attachment technique, although this implementation is not illustrated in FIG. 1.

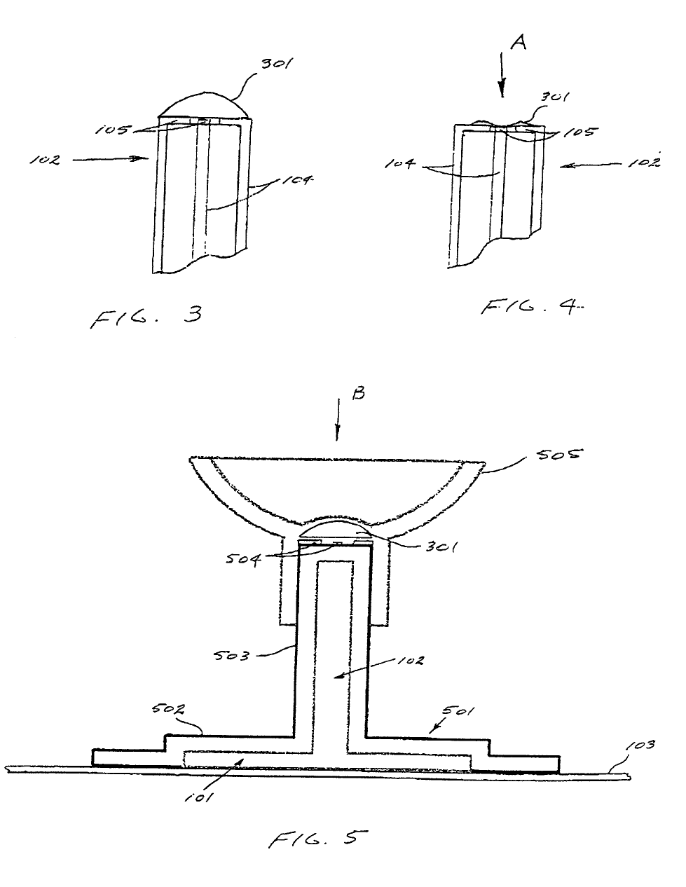

The base 101 is preferably formed from a durable, electrically insulating material, such as ceramic or alumina, that will not break readily under stress, but will still allow both compressive and tensile strains to be transmitted from the post 102 to the base 101 in the presence of an externally applied force. Other materials which may be suitable for use a base include FR4 and plastic. In the embodiment illustrated in FIG. 1, electrically conductive traces 104 are deposited on the base 101 and up the sides of the post 102 to a top surface of the post 102, terminating in a pattern of electrical contacts 105. Electrical conductivity is maintained along the conductive traces 104 from the base 101 to the electrical contacts 105. A pattern of vias 106 is utilized to make electrical contact between the conductive traces 104 and a plurality of contact pads 201 on the underside of the base 101, as shown in FIG. 2, where the position of the post 102 is indicated by dashed lines.

FIG. 2 also illustrates a plurality of force-sensing elements 202, disposed on an underside of the base 101. FIG. 2 indicates that longitudinal axes of the force-sensing elements 202 are oriented along diagonals of the base 101, although other arrangements are also possible. The force-sensing elements 202 are preferably screen-printed resistive elements, known in the art, that exhibit variations in resistance in response to tensile strain and compressive strain. For example, a tensile strain may cause the resistance of a force-sensing element 202 to increase, while a compressive strain may cause the resistance to decrease.

Each of the force-sensing elements 202 is connected by a pattern of conductive traces 203 that connects each force-sensing element 202 to a pair of electrical contacts 204 disposed near each corner of the base 101. In operation, the base 101 is affixed to an underlying printed circuit board (PCB) 103, through which electrical connections are made to the electrical contacts 201, 204 on the underside of the base 101. Electrical connection may be made through reflow soldering, for example, or through the use of conductive adhesive, or through other viable techniques as recognized in the art. In an alternative configuration (not shown), the controller maybe reverse mounted onto a PCB, in this alternative configuration the base 101 is fixed to one side of a PCB board and the post 202 extends from the base 101 through an aperture in the PCB to the other side of the PCB board. This reverse mount configuration allows for single sided stuffing of components when manufacturing PCB boards having a controller.

Provided that the base 101 is firmly affixed to the PCB 103, lateral forces (or indeed, vertically aligned forces) are readily transmitted from the post 102 to the base 101, such that direction and magnitude of applied force are easily discerned through resistance measurement of each force-sensing element 202. The base 101 could be attached to the PCB 103 through adhesive (either conductive or non-conductive), with the adhesive attachment augmented through mechanical reinforcement by bracketing or riveting (as is well-known in the art), although these features are not illustrated in the drawings. The base 101 defines a sensing plane with first and second orthogonal axes. Lateral forces applied to the post 102, which have a component along one of the axes of the sensing plane, are easily resolved in terms of direction of application and can be used, for example, to direct a cursor on a computer display in the x-y plane.

In an alternative configuration (not shown) the force sensing elements could be located on the force transmitting member (post 102) for example as screen-printed resistive elements. In the post shown in FIG. 2 a printed resistive element could be place on each of the four vertical sides of the post, with each opposing pair of resistive elements being used to measure force along one of the first and second orthogonal axes. In this alternative configuration, connections may be provided to the sensing elements using suitable conductive traces.

FIG. 3 depicts a portion of the post (or force-transmitting member) 102 of FIG. 1 illustrating the conductive traces 104 culminating in the pattern of electrical contacts 105 on an upper surface of the post 102. It should be noted that the central electrical contact of the pattern 105 is deliberately made thinner than the outside portions of the pattern 105. This is done to ensure that an electrically conductive and resiliently deformable contact member 301 that is positioned adjacent the upper surface of the post 102 does not make electrical contact between the segments or the conductive pattern 105 when the contact member 301 is at rest. The arrangement described provides a switch with tactile feedback positioned adjacent the force transmitting member 102.

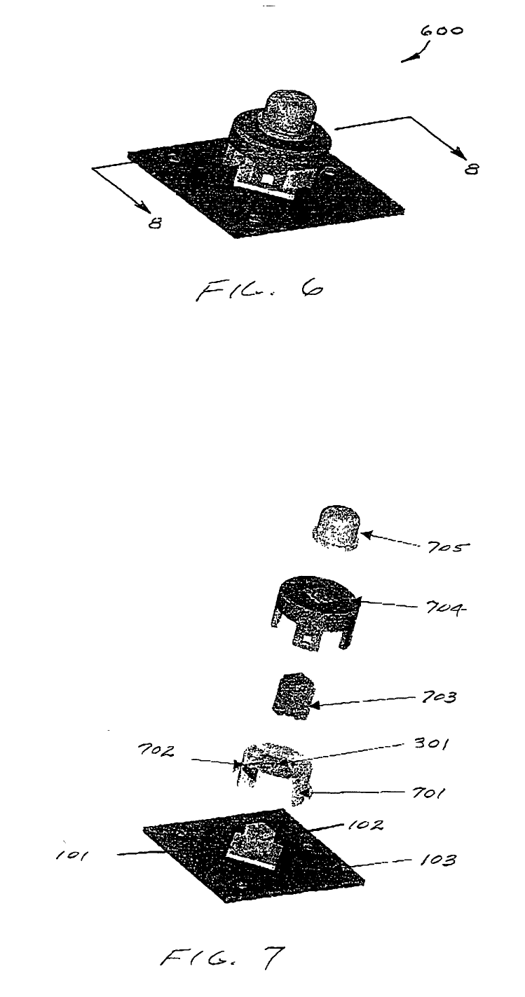

FIG. 4 depicts the configuration of FIG. 3 when the electrically conductive and resiliently deformable contact member 301 is deformed in response to a force exerted along arrow A. The conductive member 301 is pressed down until it makes electrical contact between two or more of the segments of the pattern 105, and this switch closure is detectable at the electrical contacts 201 (FIG. 2) provided on the base 101. Both a switch closure and tactile feedback to the operator are provided through this configuration. Of course, in operation, a flexible, electrically non-conductive cap is provided to hold the contact member 301 in position, although the cap is not illustrated in the drawing.

FIG. 5 depicts a variation of the configuration described above in which the base 101 and orthogonally mounted force transmitting member 102, without the conductive traces 104 depicted in FIG. 1, form the building blocks for a different implementation. Rather than disposing conductive traces upon the base 101 and post 102, a cover 501 has been devised that fits snugly about the base 101 and post 102 in combination, and makes both electrical and mechanical contact with the base 101 and the underlying PCB 103 to which the base 101 is affixed.

The cover 501 includes both a bottom portion 502 and an upstanding portion 503. As noted above, the upstanding portion 503 accommodates and substantially surrounds the post (or force transmitting member) 102 and is in contact with the base 101. The cover 501 is preferably formed from an electrically non-conductive material having conductive traces disposed upon the outer surfaces of both the bottom portion 502 and the upstanding portion 503, in much the same fashion in which the conductive traces and patterns (104, 105 in FIG. 1) are disposed in the previously described embodiment.

The electrically non-conductive cover 501 may be a two-shot molded cover having conductive traces formed thereon through plating processes. The two-shot molding and plating processes permit durable conductive traces, vias, and electrical contact areas to be deposited to a desired thickness, and even gold-flashed in electrical contact areas. Thus, electrical contact areas are easily provided on interior surfaces of the cover 501 for contact with the base 101 or PCB 103, then electrically conductive traces may be fed through by vias to the upper surface of the cover, where the conductive traces are terminated in a pattern 504 of interleaved electrical contacts similar to the pattern 105 of FIG. 1.

Of course, the cover 501 may be fabricated using any one of a variety of suitable techniques. For example, the cover may be molded in a one-shot process to include channels into which conductive material may be sputtered or otherwise deposited to form conductive traces and electrical contact patterns.

An electrically conductive and resiliently deformable contact member 301 is disposed adjacent the electrical contact pattern 504, with the centrally located portion of the pattern 504 deliberately deposited to a lesser thickness than the outer portions of the pattern 504 (as shown in FIG. 5) to avoid inadvertent switch closure. An electrically non-conductive cap 505 is movably coupled to the upstanding portion 503 of the cover 505.

Preferably, the cap 505 includes a bowl-shaped upper portion accommodating the thumb of the operator for ease of use. Actuation of the contact member 301 through downward force on the cap 505 may rely on simple displacement of the cap 505 downward toward the contact member 301 (in the direction of arrow B) or the central portion of the bowl-shaped upper portion of the cap 505 may be designed to be especially resilient. For purposes of transmitting the desired tactile feedback in conjunction with switch actuation, downward movement of the cap 505 is preferable, with the cap retreating to an initial position (by virtue of the resilient, deformable nature of the contact member 301) upon release of downward pressure.

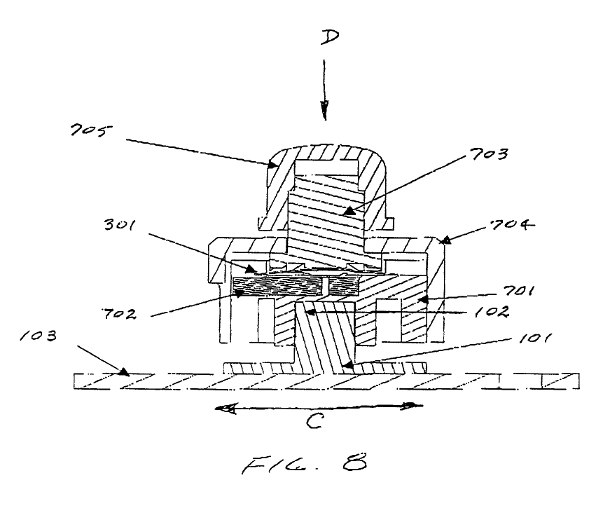

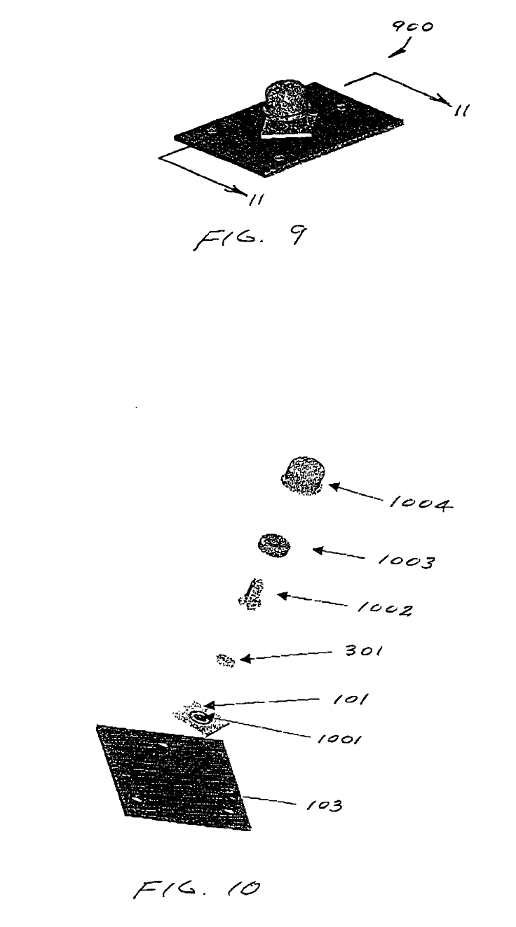

FIGS. 6, 7, and 8 depict a controller in accordance with another embodiment of the present invention. As with the controllers described previously, a base unit 101 incorporating force-sensing elements, combined with a post (or force-transmitting member) 102 are affixed to an underlying PCB 103. The post 102 of FIG. 7 is deliberately made shorter than the post 102 of FIG. 1. Nonetheless, the same reference symbol will be used in FIGS. 7 and 8 because the post is simply truncated in the embodiment of FIGS. 6-8, but is still of the same construction and serves the same purpose as previously described.

A feedback assembly is firmly affixed to the post (or force transmitting member) 102. The feedback assembly includes a base portion 701, preferably formed from an electrically non-conductive material such as plastic, that encloses a printed circuit board 702 with a pattern of electrical switch contacts disposed on an upper surface. An electrically conductive, resiliently deformable contact member 301 is disposed proximate the switch contact pattern on the PCB 702. As shown in the section view of FIG. 8, the design of the base portion 701 and PCB 702 ensures that the contact member 301 does not make electrical contact with any portion of the switch contact pattern when the contact member 301 is at rest.

An actuator 703 is disposed adjacent the contact member 301, and an upper housing 704, through which the actuator 703 extends, is installed to cover the base portion 701 and substantially enclose the contact member 301. The above-described feedback assembly is topped off by a cap 705 that fits snugly to the actuator 703.

As can be better appreciated from an examination of the section view of FIG. 8, the actuator 703 is engaged by the upper housing 704 such that the actuator 703 cannot readily be withdrawn from the housing 704. When an operator applies a lateral force (acting parallel with the arrows C, which lie in the sensing plane defined by the base 101), the feedback assembly is designed to move in the direction of the applied force in order to transmit tactile feedback to the operator.

This movement capability is preferably provided by designing the engagement of the upper housing 704 and the actuator 703 such that the actuator rocks slightly in the direction of the applied lateral force component before grounding on an upper surface of the base portion 701. After the actuator 703 grounds on the base portion 701, the component of the applied force that lies along the sensing plane is transmitted to the post 102 and thus to the force-sensing elements in the base 101. The contact member 301 provides a bias that tends to return the actuator to an upright position. Additional or alternative biasing could also be provided by spring-loading the actuator.

Of course, a downward force applied along arrow D causes the actuator to move in the direction of the applied force until the contact member 301 deforms and provides switch closure. The switch closure is electrically detectable at electrical terminations (not shown) provided on the PCB 702. When the downward force is reduced below the deformation threshold of the contact member 301, the actuator 703 returns to its initial position. Thus, the actuator, through vertical motion in response to applied force, and through the discernible deformation of the contact member 301, transmits tactile feedback to an operator.

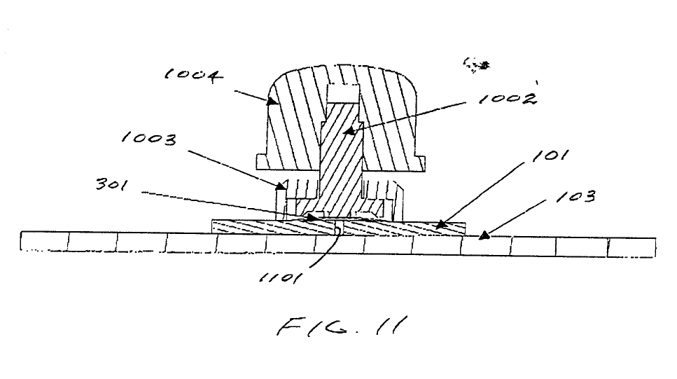

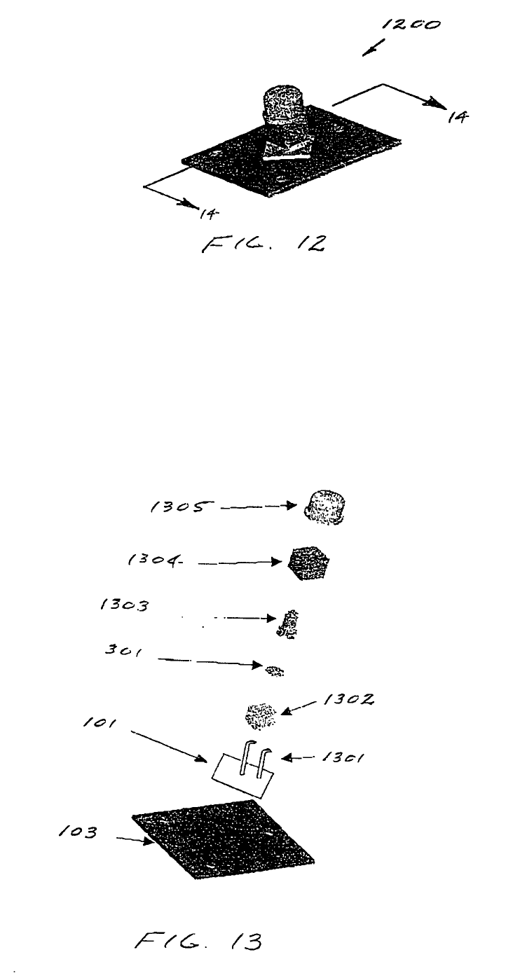

A controller in accordance with still a further embodiment of the present invention is illustrated in FIGS. 9, 10, and 11. A base 101 of the same nature as previously described is affixed to a PCB 103. However, here the embodiment of FIGS. 9, 10, and 11 diverges from the forms described above, in that no post is attached to the base 101. Instead, a conductive pattern 1001 is deposited upon an upper surface of the base 101, preferably arranged as concentric circles as indicated in order to serve as a pair of switch contacts, although other contact pattern geometries are also workable in this application. As shown in the section view of FIG. 11, the central element of the contact pattern 1001 is electrically connected to the bottom surface of the base 101 through a via 1101. The outer segment of the pattern 1001 is also connected to the bottom surface of the base 101 using a via, although this is not shown in the drawings for the sake of clarity.

An electrically conductive and resiliently deformable contact member 301 is positioned adjacent the switch contact pattern 1001. Because of the geometry of the pattern 1001 and the alignment of the contact member 301, there is no possibility of inadvertent switch closure.

A force transmitting member 1002 in the form of a post of durable, non-conductive material, such as plastic, is positioned adjacent the contact member 301. A non-conductive housing 1003, which may once again be constructed of plastic material, is firmly affixed to the base 101 and substantially surrounds the contact pattern 1001 and contact member 301. The post 1002 extends upward through a centrally located opening in the housing 1003. A cap 1004 is firmly affixed to the upper portion of the post 1002.

As can be appreciated from an examination of the drawing figures, laterally applied forces are transmitted via the post 1002 to the base 101, and are readily detected as to magnitude and direction of application by measuring changes in resistance in the force-sensing elements disposed on the bottom surface of the base 101. The post 1002 and opening in the housing 1003 through which the post 1002 extends are sized to allow the post to deflect in the direction of application of lateral forces, thus transmitting a tactile feedback to the operator. The post may be additionally biased through the provision of one or more springs if desired.

A force applied by the operator in a downward direction, along the longitudinal axis of the post 1002 (and orthogonal to the sensing plane defined by the base 101) results in downward travel of the post 1002 until the contact member 301 deforms and makes electrical contact between the segments of the switch pattern 1001. The closing of the switch provides a selection indication for cursor control applications, while the travel of the post 1002 and deformation of the contact member 301 provide tactile feedback to the operator that the desired selection operation is being carried out properly. In addition, with the post 1002 properly spring biased, as mentioned above, the electrically conductive and resiliently deformable contact member 301 may be replaced by a conductive disk (or other suitable shape, such as a conductive pill or oblate spheroid) that makes electrical contact between the segments of the switch pattern 1001, although this variation is not illustrated in the drawing figures.

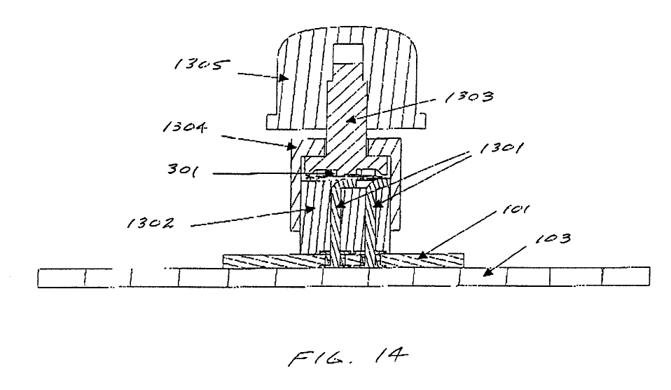

FIGS. 12, 13, and 14 depict a controller in accordance with another embodiment of the present invention. Just as previously described, a base 101 that includes force-sensing elements is attached to a PCB 103. Conductive posts 1301 are then staked into holes provided in the base. The staking operation provides a durable mechanical connection, and the connection points are preferably soldered to the base 101 in order to ensure good electrical connectivity.

A block 1302 of durable, non-conductive material, such as ceramic, for example, is then placed over the stakes 1301. The block 1302 is provided with openings therethrough to accommodate the stakes 1302. The block 1302 is preferably secured to the base 101 by adhesive to ensure a durable mechanical connection that will transmit applied forces, both lateral and vertical, to the base 101. Once the block 1302 is secured in position, the upper portions of the stakes 1301 are extruded slightly and bent over into grooves provided in the upper surface of the block 1302. This bending and extruding of the stakes 1301 can be accomplished with a simple heading operation. When the upper portions of the stakes 1301 have been bent and “spread out” into the grooves provided, these upper portions of the stakes 1301 provide a pattern of electrical switch contacts on the upper surface of the block 1302.

An electrically conductive and resiliently deformable contact member 301 is disposed adjacent the exposed pattern of switch contacts on the upper surface of the block 1302. A post 1303 of durable, non-conductive material, such as plastic, for example, is then disposed adjacent the contact member 301. A housing 1304, through which the post 1303 extends, is assembled over the block 1302, substantially surrounding and covering the switch contacts and contact member 301. A cap 1305 is then firmly affixed to the upper portion of the post 1303.

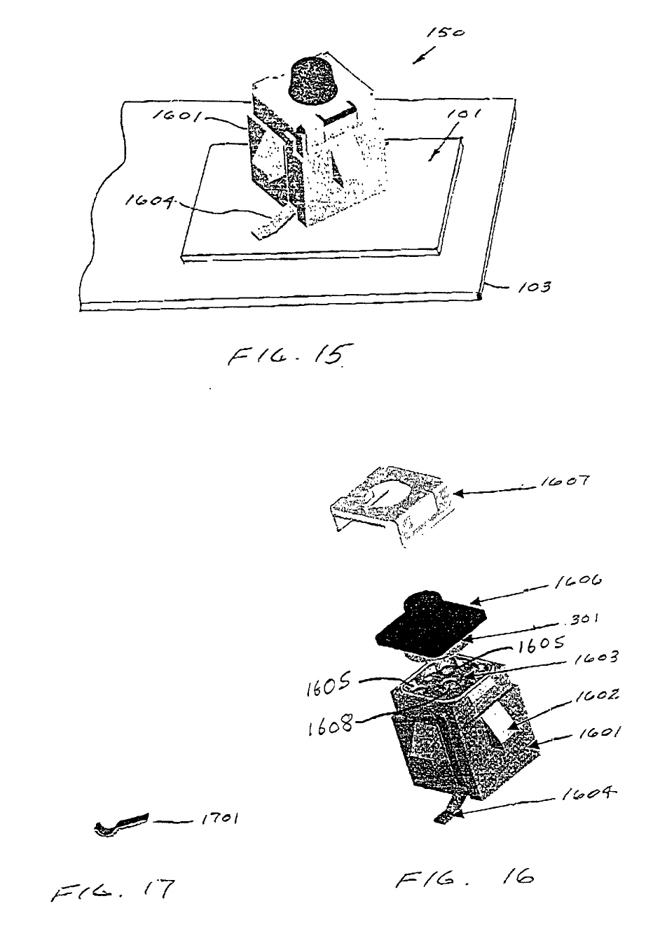

In operation, the controller of FIGS. 12, 14, and 14 acts to transmit forces laterally applied to the post 1303 into the sensing plane defined by the base 101. Once again, by designing appropriate spacing into the relationship between the post 1303 and housing 1304, the post is configured to respond to laterally applied forces by moving in the direction of the applied force, thus transmitting a tactile feedback to the operator. Vertically applied forces cause the post 1303 to move in the direction of the applied force to deform the contact member 301 and establish electrical contact between the stakes 1301, thus providing an electrical switch closure and tactile feedback to the operator associated with movement of the post 1303 in the vertical direction.

Although staking conductive posts 1301 into the base 101 and providing the associated block 1302 introduces considerable mechanical and electrical integrity into the controller assembly 1200, it is possible to introduce variations in the interest of further economy and simplicity of manufacture. For example, the staked conductive posts 1301 and insulating block 1302 may be replaced by a molded assembly that includes conductive traces and switch contacts, perhaps provided through a two-shot molding process, or perhaps by sputtering or otherwise depositing conductive traces onto a suitably shaped block-type assembly. The block assembly could then be firmly attached to the base 101. Insert molding of electrical conductors that terminate in a switch pattern is another viable way of eliminating the staked conductive posts 1301.

FIGS. 15, 16, and 17 depict a controller in accordance with yet a further embodiment of the present invention. FIG. 15 is a perspective view of the controller 1500. Just as previously described, a base 101 that includes force-sensing elements is attached to a PCB 103. The post portion 1601 of controller 1500 is attached directly to the base 101, using adhesive, for example, or adhesive combined with a mechanical press-fit in a suitable combination, as described previously in conjunction with other embodiments. Electrical connection is then made to the base 101 via electrical contact 1604. Another similar electrical contact emerges from the post 1601 on the opposite side of the controller 1500, and is not visible in the drawings.

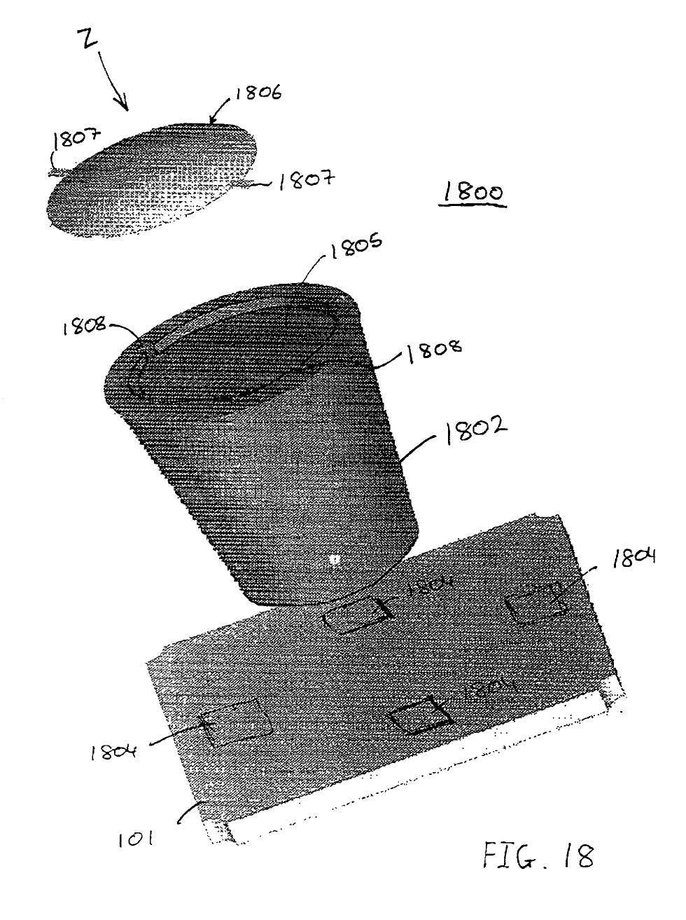

FIG. 16 is an exploded view of the controller 1500 of FIG. 15. An electrical contact area 1603 is punched or stamped from suitable sheet metal. Preferably, the contact area 1603 is punched and formed in such a way that the electrical contact 1604 is formed from the same sheet, and is simply bent appropriately such that the electrical contact 1604 emerges from the post 1601 at the desired position, and with the desired orientation. The formed electrical contact area 1603 and integrally formed electrical contact 1604 (sometimes termed a “fret”) may then be fed into an insert mold machine so that a suitable plastic material may then be overmolded to form the post 1601.

The contact area 1603 that forms the central portion of the fret preferably includes raised contact areas 1605 designed to protrude through the formed plastic of the post 1601. It should be noted that, since a switch is being provided, it may be appropriate to have two frets that can be insert molded to form the finished product. In the embodiment illustrated in FIG. 16, the raised contacts 1605 disposed proximate the interior corners of the switch area 1603 are electrically connected to electrical contact 1604. The raised contact 1608 that is centrally disposed in the contact area 1603 is electrically connected to another electrical contact similar to contact 1604, but located on the opposite side of the post 1601 where it is not visible in the drawing.

A silicone rubber pushbutton 1606 overlays the contact area 1603, with an electrically conducting and resiliently deformable contact member 301 interposed therebetween. A metal clip 1607, through which the pushbutton 1606 protrudes, snaps into place on mating protrusions along the post exterior to hold the controller assembly together. Downward force exerted on the pushbutton 1606 deforms the contact member 301 until electrical connection is established between raised contacts 1605, 1608. This electrical connection is discernible through the electrical contacts 1604, and the deforming of the contact member 301 provides tactile feedback to an operator. The silicone rubber pushbutton 1606 is also designed to exhibit “play,” or lateral travel, in response to laterally exerted forces applied to move a display cursor. Thus, the controller 1500 also provides tactile feedback to an operator in response to laterally applied forces.

FIG. 17 illustrates an alternative contact arrangement 1701 that could be used in place of the terminal portion of contact 1604. In contact 1701, the end portion is bent along a circular arc to form an electrical terminal that may then be soldered to a mating contact area on the ceramic base 101.

The controller 1500 may also be fabricated in other ways. Rather than insert-molding appropriately formed frets within a plastic post assembly, a previously manufactured switch of rectangular cross-section may simply be attached by adhesive to a plastic post assembly. The post itself may be manufactured in such a way that recesses are provided along its sides to accommodate the electrical contacts 1604 shown in FIG. 16. In the alternative, rather than employing metal frets for the raised contacts 1605, 1608 and the electrical contacts 1604, the post may be constructed using a two-shot molding process in which conductive areas corresponding to the raised contacts 1605, 1608 and the electrical contacts 1604 are simply formed by metallization, along with appropriate electrically conductive traces to interconnect these regions.

Furthermore, it should be noted that the electromechanical switch structures (switch transducers) described above, intended to be actuated by downward forces applied to the upstanding force transmitting members (or posts) of the above-described embodiments, may be replaced by other transducers that provide tactile feedback and an electrically discernible signal corresponding to downward travel of the post. For example, the post may be replaced by concentric conductors having an insulating material disposed between them. When downward force is applied to such a post, an increase in capacitance may be detected rather than the pronounced decrease in resistance that is characteristic of a switch closure. In fact, it is possible to eliminate the electrically conductive and resiliently deformable contact member of many of the above-described embodiments in favor of a spring-loaded capacitive post, while still achieving the desired tactile feedback and electrical indication that the post has moved downward to the limit of its travel.

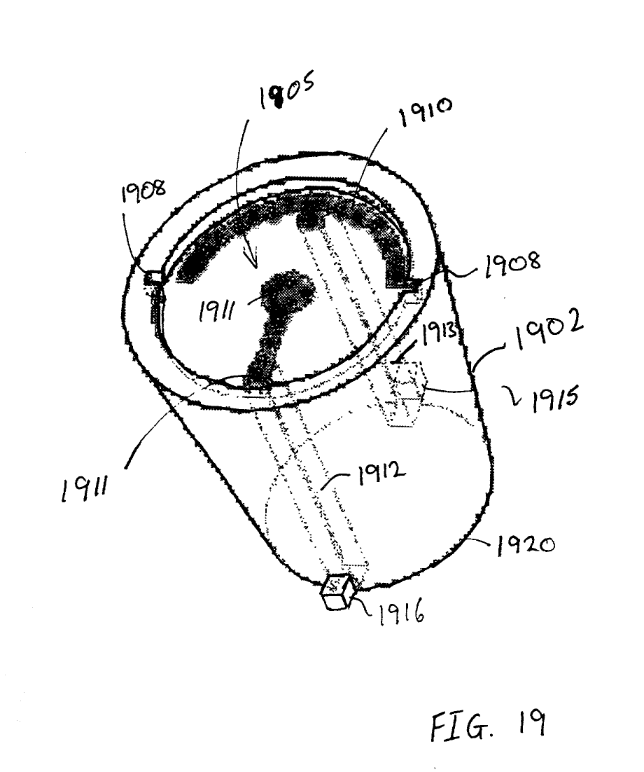

FIGS. 18 depicts an exploded view of a controller 1800 in accordance with yet a further embodiment of the present invention. The controller 1800 comprises a base 101 defining a sensing plane having first and second orthogonal axes therein and a force-transmitting member 1802 (post) orthogonally mounted to said base 101. The post 1802 defines a third axis mutually orthogonal with said first and second axes. As in the embodiments described previously, force-sensing elements 1804 are provided on the base for sensing force along said first and second orthogonal axes. The force transmitting post portion 1802 of the controller 1800 may be attached directly to the base 101, using for example adhesive, or adhesive combined with a mechanical press-fit in a suitable combination, as described previously in conjunction with other embodiments. A suitable adhesive would be an epoxy based adhesive. The post 1802 may be substantially cylindrical and made from any durable material, for example plastic, as described previously with respect to previous embodiments.

A substantially circular recess 1805 is formed in the top surface of the post and is shaped to receive a resiliently deformable member, in the present example a metal dome 1806. The metal dome 1806 may have tabs 1807 extending from its perimeter for engaging with co-operating slots 1807 formed in the post wall adjacent to the recess 1805. The metal dome 1806 may be fixed to the post using any appropriate technique, for example heat staking or snap fitting. When fixed to the post 1802, the center surface portion of the metal dome is raised with respect to the outer portion of the metal dome. The dome is resiliently deformable and flexes in response to a force applied by an operator along the axis of the post, shown by the directional arrow Z. In particular, the center portion of the dome 1806 flexes and moves downward towards the surface of the post in the recess 1805. This downward movement provides an operator with a tactile sensation. As the operator reduces the applied force below a threshold level, the center portion of the metal dome returns to its initial position. The threshold level may be pre-determined by careful selection of the shape, and composition of the dome. When an operator applies pressure to the top of the post in the direction of either the first or second axes, the dome does not deform significantly as it is protected by the region of the post 1802 surrounding the recess 1805. Thus the tactile sensation provided by the dome may be substantially limited to forces applied by an operator in a direction along said third axis Z.

In one variation of this embodiment, the dome 1806 is used to provide tactile sensation for an operator making a selection but does not form a part of the switch transducer for detecting a selection action by an operator using the controller.

A convenient way of implementing the switch transducer without using the dome 1806, is to use the sensor elements 1804, previously described with respect to other embodiments, as a switch transducer to detect forces applied by an operator to the top of the post to effect a selection action, i.e. the application of force by an operator to the post in the direction of the third axis. Any operator force applied to the post 1802 in the direction of the third axis is transmitted directly along the axis of the post to the sensor board causing a transverse pressure on the sensor board. This transverse pressure results in a tensile strain being placed simultaneously on all of the strain sensor elements 1804 on the board 101. This situation is to be contrasted with situations where force is exerted along either the first or second axis. In these situations, an increase in tensile strain in one sensor is matched by a corresponding compressive strain in an opposing sensor. Accordingly, a force exerted by an operator along the third axis may readily be identified when the characteristics of two opposing sensors change in the same way. Accordingly, the outputs from the sensors may readily be configured to produce an electrically discernible switching signal in response to an actuation force exerted in a direction along said third axis using the mutually changing characteristics of two or more opposing sensors. Suitable associated circuitry may be provided to convert the sensor outputs to a logic switching signal upon reaching a pre-defined threshold indicative of pre-defined switching force. It will be apparent that other configurations of sensor elements may also be used to achieve the same effect. For example, a separate pair of opposing strain sensors may be provided for the detection of an applied operator force indicating a selection, or a triangular pattern of strain sensors could be used to detect forces in all three axes. The threshold level of the electrically discernable switching signal should equate to a force of at least the threshold force of the metal dome 1806. In this way, the tactile sensation provided by the metal dome 1806 coincides to the production of a selection signal indicative of an operator selection.

The use of strain sensors to detect an operator selection action distinct from the feature providing tactile sensation provides a number of inherent advantages, including a simpler controller construction, no electrical (solder) connections are required between the post and base (when sensors are mounted on base), and a simpler post construction as no traces are required. Moreover, the sensors will continue to function even when the feature providing tactile sensation has failed.

FIG. 19 is a view of an alternative force transmitting member (post) suitable for use with the dome 1806 and base 101 of FIG. 18 and provides an alternative operator selection switch to the sensor method previously described in respect of FIG. 18. The post 1902 construction is as described with respect to the post 1802 of FIG. 18 except that a first pattern 1910 and a second pattern 1911 of electrical contacts are provided on the upper surface of the post in the recess 1905 formed for receiving the metal dome. The first and second patterns of contacts may be formed as the upper surfaces of leads 1912, 1913 embedded within the post 1902 and extending from the upper section of the post to the base 1920 of the post 1902. The leads 1912,1913 may be suitable shaped to extend as protrusions 1915,1916 from the post at its base 1920 to enable electrical connections be made between the first pattern of contacts and the second pattern to the sensor board for example by soldering techniques. In respect of the electrical contacts on the upper surface of the post, the first contact pattern 1910 is provided in a region adjacent to the periphery of the recess 1905 formed in the post and is preferably in contact with the metal dome once the dome has been fixed to the top of the post. The actual contact between the dome and first pattern of contacts may be made for example with a portion of the first pattern of contacts in the region of the slots 1908 in the post for receiving the tabs of a metal dome. A second pattern of electrical contacts is positioned centrally in the recess, and may be raised slightly with respect to the recess surface. The associated lead 1912 for the second pattern of contacts 1911 may be disposed in a non central location. The second pattern of electrical contacts is not in contact with the metal dome when the metal dome is at rest. As the central portion of the metal dome flexes and distorts in response to a force exerted by an operator along the direction of primary axis of the post, the metal dome comes into electrical contact with the second pattern of contacts, and thus electrically connects the first and second patterns of contacts. This connection (switch closure) is detectable at the electrical contacts 1915, 1916 provided on the base of the post 1902. In this configuration, both the function of switch closure and tactile feedback to the operator are provided by the metal dome.

In use, a flexible, electrically non-conductive, e.g. silicone rubber, cap or cover may be provided covering the top portion of the post to conceal and/or protect the metal dome, although the cap is not illustrated in either the drawings of FIG. 18 or FIG. 19.

The present invention also contemplates that audio feedback may be provided to an operator by incorporating appropriate electronic circuitry, well-known in the art, to generate a beep or click (or other sound) through an audio transducer in response to downward movement of the controller's force-transmitting member.

There has been described herein a controller with tactile feedback that offers distinct advantages when compared with the prior art. It will be apparent to those skilled in the art that modifications may be made without departing from the spirit and scope of the invention. Accordingly, it is not intended that the invention be limited except as may be necessary in view of the appended claims.

What is claimed is:

1. A controller that provides tactile feedback to an operator, the controller comprising:
a base, said base defining a sensing plane having first and second orthogonal axes therein;
a force-transmitting member orthogonally mounted to said base, said force-transmitting member defining a third axis mutually orthogonal with said first and second axes;
force-sensing elements for sensing force along said first and second orthogonal axes;
a first pattern of electrically conductive traces disposed upon an upper surface of said base;
a second pattern of electrically conductive traces disposed upon at least one side portion and a top portion of said force-transmitting member and electrically connected to said first pattern of electrically conductive traces; and
an electrically conducting and resiliently deformable contact member positioned adjacent sai top portion of said force-transmitting member.

2. The controller of claim 1, wherein said force-sensing elements are disposed on said base.

3. The controller of claim 2, wherein said base comprises a substrate having force sensing resistors disposed upon an underside thereof, and patterns of conductive traces provide electrical connections between said force sensing resistors and electrical contacts disposed proximate corner regions of said substrate underside.

4. The controller of claim 2, wherein said force-sensing elements are disposed on said force transmitting member.

5. The controller of claim 1, wherein said force transmitting member comprises an upstanding post of rectangular cross-section affixed to said base.

6. The controller of claim 1, further comprising an electrically nonconductive cap movably coupled to said force transmitting member and substantially enclosing said deformable contact member, such that said cap responds to a predetermined force exerted by the operator along said third axis by moving along said third axis in response to said force until said deformable contact member makes electrical contact with said second pattern of conductive traces, and by returning to an initial position upon reduction of said force below a threshold level.

7. A controller that provides tactile feedback to an operator, the controller comprising:
a base said base defining a sensing plane having first and second orthogonal axes therein;
a force-transmitting member orthogonally mounted to said base, said force-transmitting member defining a third axis mutually orthogonal with said first and second axes;
force-sensing elements for sensing forces along said first and second orthogonal axes,
a cover formed from electrically non-conductive material, said cover having a bottom portion and an upstanding portion thereon, wherein said upstanding portion accommodates and substantially surrounds said force transmitting member and said bottom portion is in contact with said base;
a first pattern of electrically conductive traces disposed upon said bottom portion of said cover;
a second pattern of electrically conductive traces disposed upon at least one side portion and a top portion of said upstanding portion of said cover; and
an electrically conducting and resiliently deformable contact member positioned adjacent said top portion of said upstanding portion of said cover.

8. The controller of claim 7, wherein said force-sensing elements are disposed on said base.

9. The controller of claim 8, wherein said base comprises a substrate having force sensing resistors disposed upon an underside thereof, and patterns of conductive traces provide electrical connections between said force sensing resistors and electrical contacts disposed proximate corner regions of said substrate underside.

10. The controller of claim 7, wherein said force-sensing elements are disposed on said force transmitting member.

11. The controller of claim 7, wherein said force transmitting member comprises an upstanding post of rectangular cross-section affixed to said base.

12. The controller of claim 7, wherein said cover is formed by a two-shot molding process having conductive traces formed therein through plating processes.

13. The controller of claim 7, further comprising an electrically nonconductive cap movably coupled to said upstanding portion of said cover and substantially enclosing said deformable contact member, such that said cap responds to a predetermined force exerted by the operator along said third axis by moving along said third axis in response to said force until said deformable contact member makes electrical contact with said second pattern of conductive traces, and by returning to an initial position upon reduction of said force below a threshold level.

14. The controller of claim 13, wherein said electrically nonconductive cap includes a bowl-shaped upper portion accommodating a thumb of the operator.

15. A controller that provides tactile feedback to an operator, the controller comprising:
a base, said base defining a sensing plane having first and second orthogonal axes therein;
a force-transmitting member orthogonally mounted to said base, said force-transmitting member defining a third axis mutually orthogonal with said first and second axes;
force-sensing elements for sensing forces in said first and second orthogonal axes of said sensing plane, and
a feedback assembly affixed to said force-transmitting member, said feedback assembly including an actuator disposed along said third axis and an electrical switch coupled to said actuator;
wherein said actuator responds to a predetermined actuation force exerted by the operator along said third axis by moving along said third axis in response to said actuation force, and by returning to an initial position upon reduction of said actuation force below a threshold level, said moving and returning being responsive to an electrically conducting and resiliently deformable switch element included in said electrical switch.

16. The controller of claim 15, wherein said force-sensing elements are disposed on said base.

17. The controller of claim 16, wherein said base comprises a substrate having force sensing resistors disposed upon an underside thereof, and patterns of conductive traces provide electrical connections between said force sensing resistors and electrical contacts disposed proximate corner regions of said substrate underside.

18. The controller of claim 15, wherein said force-sensing elements are disposed on said force transmitting member.

19. The controller of claim 15, wherein said force transmitting member comprises an upstanding post of rectangular cross-section affixed to said base.

20. The controller of claim 15, wherein said feedback assembly further includes a base portion formed from an electrically non-conductive material that encloses a printed circuit board with a pattern of electrical switch contacts disposed on an upper surface thereof.

21. The controller of claim 20, wherein the actuator of said feedback assembly further responds to force exerted by the operator, said force having at least a force component parallel to said sensing plane, by moving laterally in the direction of said exerted force component.

22. A controller that provides tactile feedback to an operator, the controller comprising:
a base, said base defining a sensing plane having first and second orthogonal axes therein;
first and second patterns of conductive traces disposed on an upper surface of said base;
an electrically conducting and resiliently deformable contact member positioned adjacent said upper surface of said base;
a force-transmitting member orthogonally disposed with respect to said base, and positioned adjacent said deformable contact member, said force-transmitting member defining a third axis mutually orthogonal with said first and second axes;
force-sensing elements for sensing forces in said first and second orthogonal axes of said sensing plane
a housing through which said force-transmitting member protrudes, said housing affixed to said base and substantially enclosing said patterns of conductive traces and said deformable contact member;
wherein said force-transmitting member responds to a predetermined actuation force exerted by the operator along said third axis by moving along said third axis in response to said actuation force, and by returning to an initial position upon reduction of said actuation force below a threshold level.

23. The controller of claim 22, wherein said force-sensing elements are disposed on said base.

24. The controller of claim 23, wherein said base comprises a substrate having force sensing resistors disposed upon an underside thereof, and patterns of conductive traces provide electrical connections between said force sensing resistors and electrical contacts disposed proximate corner regions of said substrate underside.

25. The controller of claim 22, wherein said force-sensing elements are disposed on said force transmitting member.

26. The controller of claim 22, further comprising a cap affixed to an upper portion of said force-transmitting member.

27. The controller of claim 22, wherein the force-transmitting member further responds to force exerted by the operator, said force having at least a force component parallel to said sensing plane, by moving laterally in the direction of said exerted force component.

28. A controller that provides tactile feedback to an operator, the controller comprising:
a base having force-sensing elements disposed thereon, said base defining a sensing plane having first and second orthogonal axes therein;
at least first and second upstanding conductive posts electrically and mechanically coupled to said base;
an electrically non-conductive support member affixed to said base, said support member having openings therethrough to accommodate said at least first and second conductive posts, such that at least a portion of said posts protrudes through an upper surface of said support member;
an electrically conducting and resiliently deformable contact member positioned adjacent said upper surface of said support member, proximate said protruding portions of said posts;
a force-transmitting member orthogonally disposed with respect to said support member, and positioned adjacent said deformable contact member, said force-transmitting member defining a third axis mutually orthogonal with said first and second axes;
a housing through which said force-transmitting member protrudes, said housing affixed to said support member and substantially enclosing said support member and said deformable contact member;
wherein said force-transmitting member responds to a predetermined actuation force exerted by the operator along said third axis by moving along said third axis in response to said actuation force, and by returning to an initial position upon reduction of said actuation force below a threshold level.

29. The controller of claim 28, wherein said force-sensing elements are disposed on said base.

30. The controller of claim 29, wherein said base comprises a substrate having force sensing resistors disposed upon an underside thereof, and patterns of conductive traces provide electrical connections between said force sensing resistors and electrical contacts disposed proximate corner regions of said substrate underside.

31. The controller of claim 28, wherein said force-sensing elements are disposed on said force transmitting member.

32. The controller of claim 28, wherein said at least first and second upstanding conductive posts are staked to said base through openings provided therein.

33. The controller of claim 28, wherein said electrically nonconductive support member affixed to said base is formed from a block of ceramic material substantially rectangular in cross-section.

34. The controller of claim 28, wherein said at least first and second upstanding conductive posts in combination with said electrically conducting and resiliently deformable contact member form an electrical switch having electrical terminals disposed upon said base.

35. A controller that provides tactile feedback to an operator, the controller comprising:
a base, said base defining a sensing plane having first and second orthogonal axes therein;
a force-transmitting member orthogonally mounted to said base, said force-transmitting member defining a third axis mutually orthogonal with said first and second axes;
force sensing elements for sensing forces in said first and second orthogonal axis of said sensing plane;
an electrical contact area disposed at an end of said force-transmitting member distal from said base;
an electrically conducting and resiliently deformable contact member positioned adjacent said electrical contact area;
a resilient, non-conductive pushbutton assembly disposed adjacent said deformable contact member;
an attachment member through which said non-conductive pushbutton assembly protrudes, said attachment member removably retaining said nonconductive pushbutton member proximate said deformable contact member;
wherein said non-conductive pushbutton assembly responds to a predetermined actuation force exerted by the operator along said third axis by moving along said third axis in response to said actuation force, and by returning to an initial position upon reduction of said actuation force below a threshold level.

36. The controller of claim 35, wherein said force-sensing elements are disposed on said base.

37. The controller of claim 36, wherein said base comprises a ceramic substrate having force sensing resistors disposed upon an underside thereof, and patterns of conductive traces provide electrical connections between said force sensing resistors and electrical contacts disposed proximate corner regions of said substrate underside.

38. The controller of claim 35, wherein said force-sensing elements are disposed on said force transmitting member.

39. The controller of claim 35, wherein said non-conductive pushbutton assembly comprises a silicone rubber assembly having a pushbutton integrally formed therein.

40. The controller of claim 35, wherein said attachment member comprises a metal clip having an opening through which said pushbutton assembly protrudes, said attachment member including engagement members removably engaged with mating features on said force transmitting member.

41. The controller of claim 35, wherein said force transmitting member comprises a plastic post of rectangular cross-section.

42. The controller of claim 35, wherein said post includes a switch assembly of rectangular cross-section secured to one end of said post, and wherein said switch assembly includes electrical contacts depending therefrom, said electrical contacts disposed at least in part within recesses formed in said post.

43. The controller of claim 35, wherein said post includes a switch integrally formed therein, wherein switch contact areas and at least a portion of associated electrical contacts are insert-molded within said post.

44. The controller of claim 35, wherein said post is formed in a two-shot molding process in which switch contact areas and associated electrical contacts are formed therein by metallization.

45. A controller comprising:
a base, said base defining a sensing plane having first and second orthogonal axes therein;
a force-transmitting member orthogonally mounted to said base, said force-transmitting member defining a third axis mutually orthogonal with said first and second axes;
force-sensing elements for sensing force along said first and second orthogonal axes;
a resiliently deformable member positioned adjacent said top portion of said force-transmitting member, wherein a portion of said deformable member flexes in response to the exertion of an actuation force in a direction along said third axis from an initial position to a deformed position and returning to the initial position upon reduction of said actuation force below a threshold level, and
a transducer switch for producing an electrically discernible switching signal in response to an actuation force exerted in a direction along said third axis.

46. The controller of claim 45, wherein said transducer switch comprises force-sensing elements for sensing force along said third orthogonal axes.

47. The controller of claim 46, wherein said force-sensing elements for sensing force along said first and second orthogonal axes also sense force along said third orthogonal axes.

48. The controller of claim 45, wherein said force-sensing elements are disposed on said base.

49. The controller of claim 45, wherein said force-sensing elements are disposed on said force transmitting member.

50. The controller of claim 45, wherein said resiliently deformable member is dome shaped.

51. The controller of claim 45, wherein said force transmitting member is a cylindrical post and the post has a recess, formed in the upper surface thereof, which is shaped to receive said resiliently deformable member.

52. The controller of claim 45, wherein the transducer switch comprises a first and second pattern of contacts formed in the upper surface of said force transmitting member wherein when the deformable member flexes to a deformed position an electrical path is formed between said first and second pattern of contacts.

53. The controller of claim 52, wherein said first and second pattern of contacts are provided as the upper surfaces of leads integrally formed in the force transmitting members and electrical connections for the transducer switch are provided as lead contacts extending from the base of said force transmitting member.
